(19) United States
(12) Patent Application Publication
(10) Pub. No.: US 2024/0018331 A1
(43) Pub. Date: Jan. 18, 2024

(54) POLYAMIDE RECOVERY FOR ENZYMATIC DEPOLYMERIZATION

(71) Applicant: Battelle Memorial Institute, Columbus, OH (US)

(72) Inventors: Matthew COLACHIS, Columbus, OH (US); Jacob LILLY, Dublin, OH (US); Edward TRIGG, London, OH (US); Kate KUCHARZYK, Columbus, OH (US); Amy Marie Heintz, Pacific Grove, CA (US); Megan MOORE, Hilliard, OH (US)

(21) Appl. No.: 18/347,821

(22) Filed: Jul. 6, 2023

Related U.S. Application Data
(60) Provisional application No. 63/389,536, filed on Jul. 15, 2022.

(51) Int. Cl. C08J 11/10; C08J 11/16; C08J 11/24

(52) U.S. Cl. CPC C08J 11/105; C08J 11/16; C08J 11/24; C08J 2377/00

(57) ABSTRACT

The present invention is directed to polyamide recovery from domestic or commercial waste. In particular, a method of polyamide recovery from domestic or commercial waste, via a selective dissolution procedure, using a methanol-calcium chloride solvent system, that isolates and recovers the polyamide at a particle size range that is particularly suitable for enzymatic depolymerization.

### FIELD

The present invention is directed to polyamide recovery from domestic or commercial waste. In particular, a method of polyamide recovery from domestic or commercial waste, via a selective dissolution procedure utilizing a methanol-calcium chloride solvent system, that isolates and recovers the polyamide at a particle size range that is particularly suitable for enzymatic depolymerization.

### BACKGROUND

Millions of tons of polymer waste are generated each year. Such polymer waste can wind-up in landfills, burned, or otherwise distributed into the ecosystem with a negative environmental impact. Various efforts have therefore been made to more efficiently recycle waste polymeric material, along with efforts to synthesize and rely upon polymeric material that will more readily biodegrade to relatively less harmful lower molecular weight compounds.

Among the largest source of polymeric waste, is carpet material, which relies upon the use of various polymeric resins, in fiber form. Carpet material is often sourced from various different polymeric resins, with the majority of carpets relying upon synthetic fibers such as polyamides (nylons), polyester (e.g. PET), polyacrylonitrile, and polypropylene. Natural fibers that make their way into carpet can include wool, cotton, and silk.

One of the issues surrounding the recycling of carpet waste is that carpet waste often contains several different types of comingled polymeric materials. Carpet may also include various amounts of other filler components, such as pigments, inorganic filler, anti-static agents, and stain blockers. A need therefore remains for improved methods of selectively isolating polyamides from carpet waste that is then provided in a form that would improve the efficiency of enzymatic depolymerization and the recovery of polyamide monomeric components. Such monomer components can then be utilized in downstream polycondensation reactions to prepare new polyamide resins.

### SUMMARY

A method for recovering polyamide material from waste for enzymatic depolymerization. The method starts with supplying waste containing polyamide material and placing such waste containing polyamide material in a solvent comprising methanol containing calcium chloride. This is then followed by selectively dissolving the polyamide material in the waste with the methanol-calcium chloride solvent and then precipitating the polyamide material from the methanol-calcium chloride solvent at a particle size of 20 nm to 100 μm. This is then followed by subjecting the polyamide material having a particle size of 20 nm to 100 μm to enzymatic depolymerization.

### BRIEF DESCRIPTION OF THE DRAWINGS

FIG. 1 provides an x-ray diffraction plot of intensity versus 20 for the indicated samples.

FIG. 2 provides a differential scanning calorimetry thermogram for polyamide recovered from a methanol-calcium chloride solvent in accordance with the present invention.

FIG. 3 shows a preferred particle size distribution for a sample of nylon-6 recovered from the methanol-calcium chloride solvent system.

FIG. 4 shows the preferred particle size distribution for a sample of nylon-6 recovered from the methanol-calcium chloride solvent system via the use of sonication.

### DETAILED DESCRIPTION OF PREFERRED EMBODIMENTS

The present invention is directed at polyamide recovery from domestic or commercial waste which recovered polyamide is particularly suitable for enzymatic depolymerization. Domestic and/or commercial waste typically contains a mixture of polymeric resins that has been discarded by a consumer and/or discarded from a given commercial operation. In particular, the domestic and/or commercial waste herein comprises carpet material, where the polymeric resins used to manufacture the carpet are unsorted and presented in fiber form. Reference to waste herein includes domestic and/or commercial waste.

The polymeric fiber material utilized in carpet typically relies upon a plurality of different synthetic polymeric resins, such as polyamides (nylons), polyesters (e.g. PET), polyacrylonitrile, and polypropylene. In addition, carpet can be sourced from wool, cotton and silk. The polyamide material in the carpet fiber waste stream may therefore be the major component (greater than or equal to 50.0% by weight) or it may be present in minor amounts (less than 50.0% by weight) where there are then other non-polyamide materials having major component proportions.

In preferred embodiment, the carpet herein that is subjected to polyamide recovery includes, as a major component, aliphatic polyamide fiber, which is reference to polyamides that contain aliphatic (e.g., —CH₂—) type units between amide (—NHCO—) linkages. Examples of aliphatic polyamides recovered herein include nylon-4,6, nylon-6, nylon-6,6, nylon-6,10 and/or nylon-11. For example, nylon-6 is reference to the polymeric repeating unit —[(CH₂)₅CONH]ₙ— where n is reference to the number of such repeating units, or degree of polymerization. Nylon-6,6 is reference to the polymeric repeating unit —[NH(CH₂)₆NHCO(CH₂)₄CO]ₙ— where n is again reference to the number of such repeating units or degree of polymerization. Accordingly, the degree of polymerization and molecular weight of the polyamides herein that are contemplated for recovery may fall in the range of 10,000 to 75,000, more preferably 10,000 to 50,000.

As may therefore now be appreciated, one specific preferred embodiment of the present invention is to provide carpet waste, containing mixtures of polymeric resins in fiber form, which are not sorted, and which includes polyamide fiber, along with other various additives. The polyamide fiber component is therefore selectively removed and recovered from such carpet waste in relatively pure form. That is, the recovered polyamide herein is contemplated to have a purity of at least 95.0% (wt.) or greater, meaning that the recovered polyamide has less than or equal to 5.0% by weight of any other ingredient (e.g., non-polyamide polymer or carpet additive). Accordingly, the polyamide recovered herein is contemplated to contain a maximum of 5.0% by weight, or a maximum of 4.0% by weight, or a maximum of 3.0% by weight, or a maximum of 2.0% by weight, or a maximum of 1.0% by weight, or a maximum of 0.5% by weight, or a maximum of 0.1% by weight, of non-polyamide polymer or carpet additive.

The recovery of the polyamide herein from a domestic or commercial waste is accomplished by use of a methanol-calcium chloride (CH₃OH—CaCl₂) solvent system. The methanol-calcium chloride solvent system is reference to methanol in combination with calcium chloride, where the calcium chloride is preferably present to provide a 1.5 M to 2.5 M solution of calcium chloride in methanol, including all individual molar values and all incremental molar values therein. To achieve concentrations over 2.1 M, elevated temperatures may be utilized as discussed further herein. For example, the waste carpet material is mixed with a 1.9 M to 2.2 M solution of calcium chloride in methanol, or even more preferably, a 2.0 M to 2.2 M solution of calcium chloride in methanol, or even a 2.1 M solution of calcium chloride in methanol.

The mixture of the waste carpet with the methanol-calcium chloride is preferably carried out for a time and temperature to effect selective dissolution of the entirety of the polyamide polymer component present. For example, the methanol-calcium chloride may preferably and selectively dissolve the entire polyamide polymer in the waste at room temperature (25° C.) after mixing for a period of time up to 24.0 hours. Increasing the temperature to about 55° C. will then reduce the time required for the selective dissolution of the polyamide. For example, increasing the temperature to 45° C. to 55° C. is contemplated to be sufficient to selectively dissolve the entire polyamide from a carpet waste sample after a period of up to 1.0 hours. In the broad context of the present invention, the mixing of the waste carpet with the methanol-calcium chloride solution herein is preferably carried out for a period of 0.5 hours to 24.0 hours, at a temperature range from 25.0° C. to 55° C., including all individual time and temperature values and increments therein.

The loading level of carpet waste in the methanol-calcium chloride solution herein may preferably be in the range of 0.1% (wt.) to 25.0% (wt.), including all individual values and increments therein. For example, the loading levels of carpet waste in the method-calcium chloride solution herein may be in the range of 0.1% (wt.) to 20.0% (wt.), or 0.1% (wt.) to 15.0% (wt.) or 0.1% (wt.) to 10.0% (wt.) or 0.1% (wt.) to 5.0% (wt.), or 0.1% (wt.) to 3.0% (wt.).

The methanol-calcium chloride solution containing the dissolved polyamide may then be configured to precipitate the polyamide for recovery. This is preferably achieved by introduction of water. For example, 1 part of the methanol-calcium calcium chloride solution may be introduced into 10 parts of water to force the polyamide out of solution. This may be followed by stirring for a period of 0.5 hours to 2.0 hours, more preferably a period of 0.75 hours to 1.25 hours. The precipitated polyamide is then conveniently removed by solid-liquid filtration.

Table 1 below provides the results of three (3) examples where polyamide was selectively removed from carpet waste. The carpet sample was identified as Boxton LifeProof™ Versatile Beige carpet. Such carpet was placed in a 2.1 M solution of calcium chloride in methanol, at room temperature, at the indicated concentrations. The solution with the carpet was stirred overnight. The solution was then poured into the indicated amount of water with stirring for about 1.0 hour.

TABLE 1
Polyamide Removal From Waste Carpet

| | | Carpet | CaCl₂/ | | Water | Final | Carpet |
|---|---|---|---|---|---|---|---|
| | | Mass | CH₃OH | Conc. | Added | Carpet | Backing |
| Sample | Description | (g) | (g) | w/w | (g) | Weight | Weight (g) |
| 1 | Boxton LifeProof ™ | 0.2215 | 15 | 1.5 | 150 | 0.0676 | 0.1132 |
| 2 | Boxton LifeProof ™ | 0.2446 | 15.2 | 1.6 | 150 | 0.0593 | 0.1492 |
| 3 | Boxton LifeProof ™ | 0.2325 | 15 | 1.6 | 150 | 0.0669 | 0.1226 |

For the three (3) working examples above, the percent mass loss after dissolution and % mass recovery were on average 45.1%+/−5.3% and 61.8%+/−0.8%.

X-ray diffraction was performed on the recovered polymeric material from Sample 2 (Table 1) noted above and compared with two known polyamide (nylon-6) samples. More specifically, a known sample of nylon-6 film subjected to methanol-calcium chloride dissolution and precipitation, and a pure nylon-6 powder. The results of the X-ray diffraction are shown below in Table 2.

TABLE 2
X-Ray Diffraction Data

| | Crystallinity | Crystal |
|---|---|---|
| Sample\Description | Index (%) | Size (nm) |
| Nylon-6 Film Precipitated from | 37 | 8.4 |
| CH₃OH—CaCl₂ | | |
| Sample 2 | 33 | 10.1 |
| Nylon Powder | 35 | 16.5 |

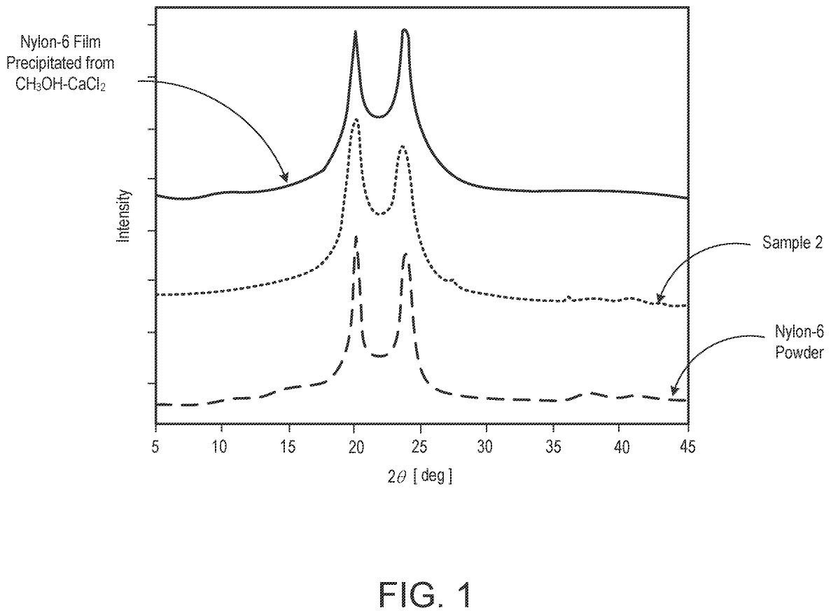

Reference is also made to FIG. 1 which provides an x-ray diffraction plot of intensity versus 20 for the indicated samples. The dominant peaks at 20.1° and 23.9° correspond to the crystalline alpha-phase of nylon-6. As can be seen, the polyamide nylon-6 is recovered herein in a semicrystalline form after recovery from carpet waste employing the methanol-calcium chloride solvent system herein.

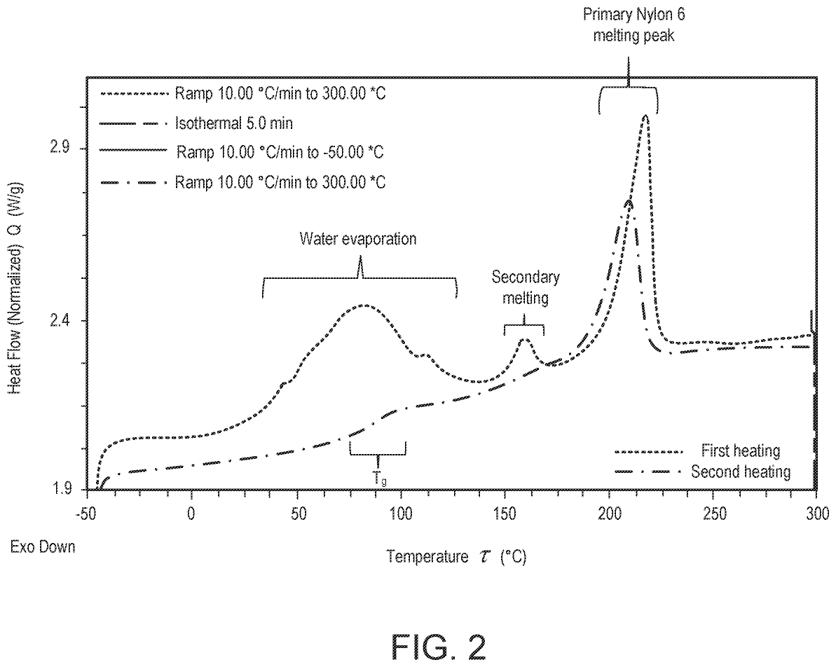

Differential scanning calorimetry (DSC) was next applied to characterize the polyamide recovered from the waste carpet herein. More specifically, Sample 2 (Table 1) was evaluated by DSC to further verify the relative purity of the recovered polyamide (nylon-6). It is worth noting the nylon-6 is hydroscopic and typically contains around 5.0% (wt.) water. The sample was heated, cooled, and heated again in the DSC. Table 3 below identifies the results. The DSC thermogram appears in FIG. 2.

| | | Peak | | |
|---|---|---|---|---|
| | | Temperature | Enthalpy | Relevant |
| Scan | Assignment | ° C. | J/g | Analysis |
| First | Water | 82 | 94.8 | 4% Absorbed |
| Heating | Evaporation | | | Water |
| First | Nylon-6 Secondary | 160 | 6.0 | 3% |
| Heating | Melting | | | Crystallinity |
| First | Nylon-6 Primary | 217 | 62.9 | 27% |
| Heating | Melting | | | Crystallinity |
| Second | Nylon-6 Tg | 83 | — | — |
| Heating | | | | |
| Second | Nylon-6 Primary | 209 | 56.3 | 24% |
| Heating | Melting | | | Crystallinity |

From the above, the first heating scan of Sample 2 (Table 1) was observed to have three endothermic peaks, assigned to water evaporation, possible secondary melting of nylon-6, and primary melting of nylon-6. In the second heating scan, the glass transition (Tg) of nylon-6 was observed along with primary melting. This DSC analysis confirms that the polyamide recovered from carpet using the methanol-calcium chloride solvent system herein, leads to a morphology with identifiable crystallinity.

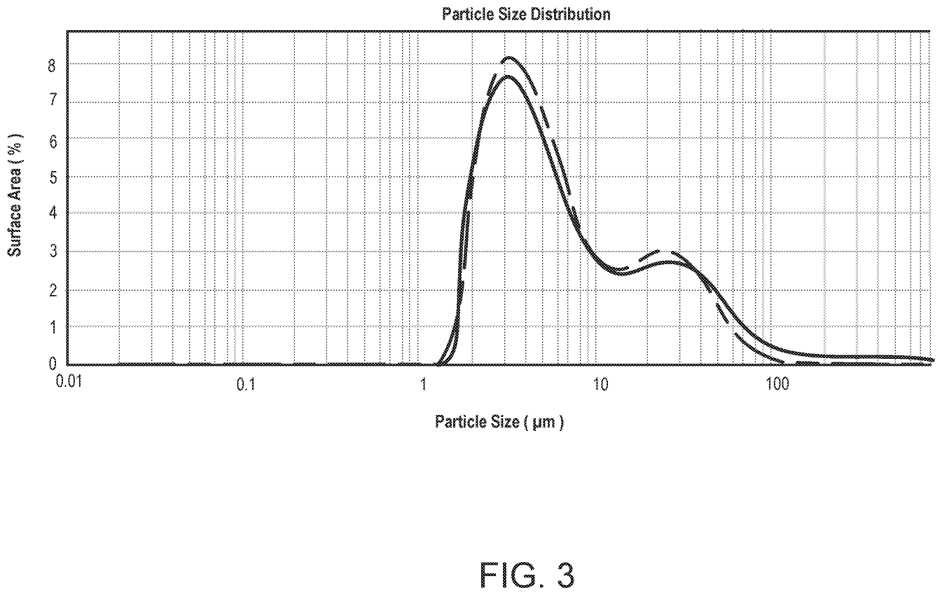

An evaluation was next conducted to assess the particle size distribution one can achieve for recovered polyamide from carpet waste, utilizing the herein described methanol-calcium chloride solvent. Attention is directed to FIG. 3 which shows a preferred particle size distribution plot achieved herein for sample of nylon-6 (0.8 wt. %) dissolved and then precipitated and recovered from a methanol-calcium chloride solution. As can be observed, the particle size of the recovered polyamide falls in the general range of 1.0 μm to 100 μm. More preferably, a majority (50% or more) of the polyamide recovered herein using the methanol-calcium chloride solvent system is contemplated to provide a particle size in the range of 1.0 μm to 10.0 μm, including all individual values and increments therein. For example, 50% or more of the recovered polyamide provides a particle size in the range of 1.0 μm to 9.0 μm, or 1.0 μm to 8.0 μm, or 1.0 μm to 7.0 μm, or 1.0 μm to 6.0 μm, or 1.0 μm to 5.0 μm, or 1.0 μm to 4.0 μm, or 1.0 μm to 3.0 μm, or 1.0 μm to 2.0 μm. One particularly preferred particle size of the polyamide recovered herein utilizing the methanol-calcium chloride solvent system is contemplated to fall in the range of 2.0 μm to 4.0 μm.

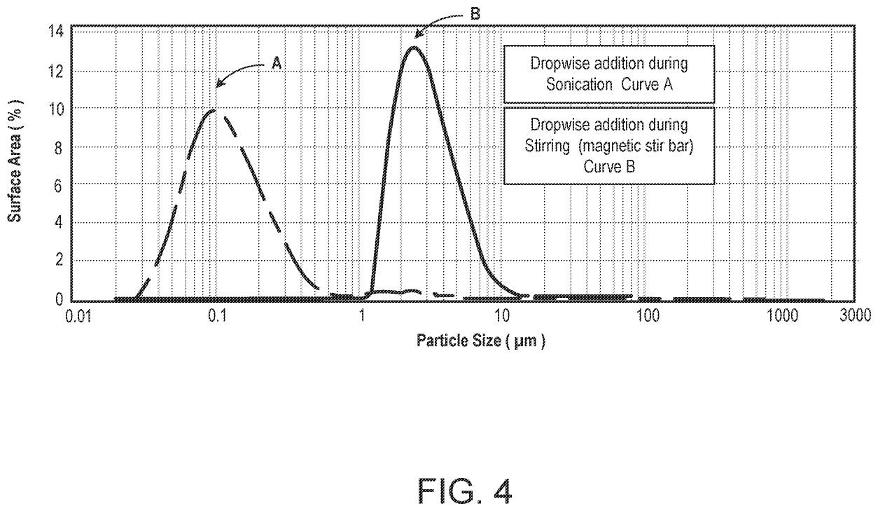

Attention is next directed to FIG. 4, which illustrates how the particle size of the recovered polyamide can be made to further fall in the range of less than or equal to 1.0 μm (1000 nm), or in the range of 20 nm to 1000 nm, including all individual values and increments therein. More specifically, nylon 6 was dissolved (2.0 weight percent) in a solution of 2.1M CaCl₂) in methanol. Then, 4.2 grams of this nylon-6 solution was added dropwise to 40 ml of water. A probe sonicator, which provides sound energy, was submerged in the water and powered on during the dropwise addition. The particle size of the nylon-6 recovered is shown as curve “A” in FIG. 4. Curve “B” shows the particle size of the polyamide recovered from dropwise addition with stirring. As can be seen, the particle size resulting from sonicating while precipitating is now less than or equal to 1.0 micron, and falls in a preferred range of 20 nm to 1000 nm, or even 20 nm to 900 nm. In addition, the distribution of the particles recovered during precipitation with sonication was as follows: D(0.1)=53 nm, D(0.5)=110 nm and D(0.9)=283 nm. Accordingly, 90% of the nylon-6 particles recovered by dissolving in a CaCl₂)/methanol solution and recovering by dropwise addition to water, in the presence of sonication, had a particle size smaller than 283 nm, 50% of the particles had a particle size smaller than 110 nm, and 10% of the particles had a size smaller than 53 nm.

It next is noted that the recovery of the polyamide herein from carpet waste is contemplated to be particularly suitable for enzymatic depolymerization. Accordingly, the recovered polyamide herein at a particle size of 20 nm to 100 μm, or at 20 nm to 10.0 μm, or at 20 nm to 5.0 μm, or at 20 nm to 1000 nm, including all individual values and increments therein, may then be depolymerized to monomeric components. This can be achieved by treating the recovered polyamide at such particle size ranges with an enzyme composition comprising one or more of protease, manganese peroxidase, and/or cutinase.

Protease is reference to enzymes that are capable of cleaving amide bonds in the recovered polyamide particles via hydrolysis (reaction with water). In the case of nylon-6, this is contemplated to result in the depolymerization and formation of relatively lower molecular weight nylon-6 and ultimately, monomeric components such as amino acids, e.g., aminocaproic acid, which then may be employed for polymerization and reformation of nylon-6. Similarly, in the case of nylon-6,6, treatment with protease is contemplated to result in relatively lower molecular weight polyamide and ultimately, the components of adipic acid and hexamethylenediamine. The adipic acid and hexamethylene diamine may then serve as a feedstock for the polymerization and production of virgin nylon-6,6. One particular preferred protease for depolymerization of polyamides herein is contemplated to be subtilisin. Subtilisin may be preferably sourced from soil bacteria, e.g., Bacillus amyloliquefaciens, from which they are secreted.

Other suitable enzymes that are contemplated for enzymatic depolymerization of the recovered polyamide particles includes treatment with manganese peroxidase and/or cutinase. In either case, the enzymatic depolymerization of the polyamide particles, with these two additional enzymes, are again contemplated to result in the ability to recover lower molecular weight polyamides and ultimately the monomeric components of the polyamide, which monomeric components can again be relied upon for polymerization for formation of virgin polyamide material.

Preferably, the enzyme is added to a buffer solution, such as 0.1 M sodium phosphate buffer, at a concentration of 0.01-0.1 mg/mL. The recovered polyamide herein at the indicated particle size can then be added to this enzyme/buffer solution at a preferred concentration of 10-100 mg/mL. The mixture is preferably heated to an incubation temperature, which is preferably between 30° C. and 70° C. and may be agitated. Incubation preferably proceeds for 1-10 days, to provide for enzymatic depolymerization and recovery of relatively lower molecular weight material and/or the monomeric components of the recovered polyamide.

1. A method for recovering polyamide material from waste for enzymatic depolymerization comprising:
a. supplying waste containing polyamide material;
b. placing said waste containing polyamide material in a solvent comprising methanol containing calcium chloride;
c. selectively dissolving the polyamide material in said waste with said methanol-calcium chloride solvent;
d. precipitating said polyamide material from said methanol-calcium chloride solvent at a particle size of 20 nm to 100 μm;
e. subjecting said polyamide material having a particle size of 20 nm to 100 μm to enzymatic depolymerization.

2. The method of claim 1 wherein said waste material comprises carpet material.

3. The method of claim 1 wherein said waste containing polyamide is placed in said solvent comprising methanol containing calcium chloride at a loading level in the range of 0.1% (wt.) to 25.0% (wt.).

4. The method of claim 1 wherein said methanol containing calcium chloride comprises a 1.5 M to 2.5 M solution of calcium chloride in methanol.

5. The method of claim 1 wherein said waste containing polyamide material is placed in said solvent comprising methanol containing calcium chloride and mixed for a period of time of 0.5 hours to 24.0 hours at a temperature of 25° C. to 55° C.

6. The method of claim 1 wherein said precipitation of said polyamide material comprises adding water to said methanol-calcium chloride solvent.

7. The method of claim 1 wherein said precipitated particle size of polyamide material is in the range of 20 nm to 10.0 μm.

8. The method of claim 1 wherein said precipitated particle size of polyamide is in the range of 20 nm to 5.0 μm.

9. The method of claim 1 wherein said precipitated particle size of polyamide is in the range of 20 nm to 1.0 μm.

10. The method of claim 1 wherein said step of precipitating said polyamide material from said methanol-calcium chloride solvent includes sonicating while precipitating.

11. The method of claim 1 wherein said enzymatic depolymerization comprises subjecting said polyamide to treatment with protease.

12. The method of claim 1 wherein said enzymatic depolymerization comprises subjecting said polyamide to treatment with manganese peroxidase.

13. The method of claim 1 wherein said enzymatic depolymerization comprises subject said polyamide to treatment with cutinase.
